(19) United States
(12) Patent Application Publication
(10) Pub. No.: US 2012/0243614 A1
(43) Pub. Date: Sep. 27, 2012

(54) ALTERNATIVE BLOCK CODING ORDER IN VIDEO CODING

(76) Inventors: Danny Hong, New York, NY (US); Jill Boyce, Manalapan, NJ (US); Adeel Abbas, Passaic, NJ (US)

(21) Appl. No.: 13/423,671

(22) Filed: Mar. 19, 2012

Related U.S. Application Data
(60) Provisional application No. 61/466,123, filed on Mar. 22, 2011.

(51) Int. Cl. H04N 7/12

(52) U.S. Cl. 375/240.24; 375/E07.026

(57) ABSTRACT

Systems and methods for video decoding include receiving at least one syntax element indicative of a block coding order (BCO); and decoding at least one block in accordance with the BCO. Systems and methods for video encoding include determining for at least one region of a picture a block coding order (BCO) different than scan order; encoding at least one syntax element indicative of the determined BCO; and encoding at least one block; wherein the availability of at least one sample for prediction in the encoding process is determined by the BCO.

### PRIORITY CLAIM

This application claims priority to U.S. Provisional Application Ser. No. 61/466,123, filed Mar. 22, 2011, titled “Alternative Block Coding in Video Coding,” the disclosure of which is hereby incorporated by reference in its entirety.

### FIELD

The present application relates to video coding, and more specifically, to the representation of information related to the location in a reconstructed picture of reconstructed coding units, macroblocks, or similar information, in relation to their order in a coded video bitstream.

### BACKGROUND

Video coding refers herein to techniques where a series of uncompressed pictures is converted into an, advantageously compressed, video bitstream. Video decoding refers to the inverse process. Many image and video coding standards such as ITU-T Rec. H.264 “Advanced video coding for generic audiovisual services”, 03/2010, available from the International Telecommunication Union (“ITU”), Place de Nations, CH-1211 Geneva 20, Switzerland or http://www.itu.int/rec/T-REC-H.264, and incorporated herein by reference in its entirety, or High Efficiency Video Coding (HEVC), which is at the time of writing in the process of being standardized, can specify the bitstream as a series of coded pictures, each coded pictures being described as a series of blocks, such as macroblocks in 11.264 and largest coding units in HEVC. At the time of writing, the current working draft of HEVC can be found in Bross et. al, “High Efficiency Video Coding (HEVC) text specification draft 6” February 2012, available from http://phenix.it-sudparis.eu/jct/doc_end_user/documents/8_San%20Jose/wg11//JCTVC-H1003-v21.zip. The standards can further specify the decoder operation on the bitstream.

In video decoding according to H.264, for example, the blocks are reconstructed using in-picture predictive information from blocks located, in raster scan order, before (earlier in the picture than) the block under reconstruction, as shown in FIG. 1. When reconstructing a given block, information related to already reconstructed neighboring blocks can be used for in-picture prediction of the block currently under reconstruction. This information can be in the form of reconstructed pixels (for example for intra coding), or information closely associated to properties coded in the bitstream (for example coding modes or motion vectors), or in other forms.

For example, when reconstructing block 101 (having a CN of 6), the coded information of the blocks spatially located to its left 102 and above 103, 104, 105 can be available for prediction, as these blocks 102, 103, 104, 105 may have been previously reconstructed as they are, in scan order, located before block 101. In video coding terminology, blocks 102, 103, 104, and 105 can be described as being “available” for reconstruction of block 101. The nature of availability, in this example, is a direct result of two factors: the available blocks 102, 103, 104, 105 are direct neighbors of the block under reconstruction 101, and more relevant for this description, they are, in scan order, located “before” the block under reconstruction 101. The remaining blocks, shown in greyshade, are not “available” in this sense.

Many techniques have been proposed, and sometimes included in video coding standard(s), to modify the availability of blocks for reconstruction of a given block.

At picture boundaries, blocks may not be available for in-picture prediction. For example, there is no block available for prediction when reconstructing block 103, because this block has no neighbors to its left or above.

Slices allow an interruption in the in-picture prediction at a given block in scan order. As a result, one or more of the blocks that would be available without the presence of a slice header can become unavailable. For example, if a slice header 106 were inserted in the bitstream after block 103, block 103 may not be available for the reconstruction of block 101 even if it is located, in scan order, before block 101 and a direct neighbor.

The slice group concept of H.264, alternatively known in the academic literature as “Flexible Macroblock Ordering” (or “FMO”) allows, through means irrelevant for this description, for the marking as unavailable certain blocks that would normally be available. For example, when reconstructing block 101, using FMO, it is possible to indicate that blocks 102 and 104 are available, but blocks 103 and 105 are not.

Objects such as rectangular slices (in H.263 Annex K) or tiles (in HEVC) allow for the creation of (normally rectangular shaped) areas in the picture in which the decoding process operates, to a certain extent as specified in the relevant standards, independent from other regions of the picture. In this context, relevant for this description is the fact that the scan order is maintained within those rectangular regions.

U.S. patent application Ser. No. 13/347,984, filed Jan. 11, 2012 and entitled “Render-Orientation Information In Video Bitstream,” incorporated herein by reference in its entirety, describes a rotation indication that may be added to a high level syntax structure to signal the need to rotate a reconstructed picture. Rotation is applied on the pixel level and not by changing the scan order.

At least one proposal to the Joint Collaborative Team for Video Coding (JCTVC) relates to the encoding or decoding order of blocks. JCTVC-C224 (Kwon, Kim, “Frame Coding in vertical raster scan order”, Oct. 10, 2010, available from http://phenix.int-evry.fr/jct/doc_end_user/documents/3_Guangzhou/wg11/JCTVC-C224-m18264-v1-JCTVC-C224.zip) describes the (potentially content-adaptive) use of two different pixel scan orders for a given picture: horizontal, or rotated 90 degrees clockwise. The availability information for blocks in the rotated case is hinted in a single sentence and figure, without further description. Also, only a single rotational direction is described, while other rotational directions can equally be helpful for coding efficiency. Additionally, JCT-C224 does not describe a way to support different rotational directions for different regions of the picture.

There remains a need therefore for a method and apparatus that allows changing the scan order and, advantageously, the availability of blocks for reconstruction in video decoding and coding.

### SUMMARY

The disclosed subject matter, in one embodiment, provides for a module to determine an availability of at least one block based on a given block and a mode indicating a block coding order (“bco_mode”).

In the same or another embodiment, bco_mode can be coded in a high level data structure such as a sequence parameter set, picture parameter set, slice parameter set, slice header, tile header, or other appropriate data structure.

In the same or another embodiment, bco_mode can represent rotation of the raster scan order by at least two of 0, 90, 180, and/or 270 degrees.

In the same or another embodiment, bco_mode can indicate “flexible” scan order.

In the same or another embodiment, a flexible scan order can be defined in a high level data structure, which can be a different high level data structure than the data structure wherein bco_mode resides.

In the same or another embodiment, the techniques described above and elsewhere herein can be implemented using various computer software and/or system hardware arrangements.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of a picture comprising blocks in raster scans order, in accordance with Prior Art;

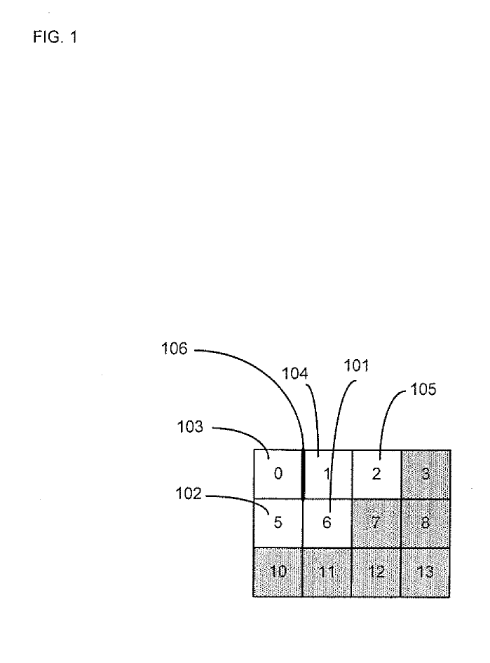

FIG. 2 is a schematic illustration of pictures comprising blocks in BCOs in accordance with an embodiment of the disclosed subject matter;

FIG. 3 is a schematic illustration of pictures comprising blocks in four BCOs using picture segmentation in accordance with an embodiment of the disclosed subject matter;

FIG. 4 is a syntax diagram in accordance with an embodiment of the disclosed subject matter;

FIG. 5 is a schematic illustration of four different BCOs within an LCU;

FIG. 6 is a schematic illustration of four different BCOs within a CU;

FIG. 7 is a schematic illustration of four different BCOs within a PU;

FIG. 8 is a schematic illustration showing the position of neighboring samples for four different BCOs;

FIG. 9a is a schematic illustration showing the direction of intra luma prediction for BCO mode 0;

FIG. 9b is a schematic illustration showing the direction of intra luma prediction for four different BCOs;

FIG. 10 is a schematic illustration showing the location of neighboring samples used in deriving the previously coded, neighboring CUs for four different BCOs;

FIG. 11 is a schematic illustration showing neighboring samples used to derive motion prediction information, for four different BCOs; and

FIG. 12 is an illustration of a computer system suitable for implementing an exemplary embodiment of the disclosed subject matter.

The Figures are incorporated and constitute part of this disclosure. Throughout the Figures the same reference numerals and characters, unless otherwise stated, are used to denote like features, elements, components or portions of the illustrated embodiments. Moreover, while the disclosed subject matter will now be described in detail with reference to the Figures, it is done so in connection with the illustrative embodiments.

### DETAILED DESCRIPTION

### Overview

Described are methods and systems for video decoding, and corresponding techniques for encoding a picture utilizing a Block Coding Order (“BCO”) indication. The BCO can be indicative of an ordering scheme from which the availability of blocks can be derived.

Several acronyms used in this description are set forth below for ease of explanation (and such definitions are not intended to limit the scope of the disclosed subject matter in any way); in some cases, similar terms are used in HVEC:
BCO: block coding order
LCU: largest coding unit, also referred to as a TB (tree block)
CU: coding unit
PU: prediction unit
TU: transform unit
CN: coding number
Slice: a sequence of LCUs in BCO; each picture comprises at least one slice.
LCU address: a unique number assigned to each LCU, where the top-left LCU of the picture is assigned the address 0 and the address increases for each LCU in raster scan order (left-to-right, and top-to-bottom), independent of the BCO.
CU index: a number indicating the location of a CU with respect to the top-left sample of its LCU.
PU index: a number indicating the location of a PU with respect to the top-left sample of its LCU.
TU index: a number indicating the location of a TU with respect to the top-left sample of its LCU.
LCU CN: a number specifying the BCO of each LCU.
CU CN: a number specifying the BCO of each CU within an LCU.
PU CN: a number specifying the BCO of each PU within a CU.
TU CN: a number specifying the BCO of each TU within a CU.

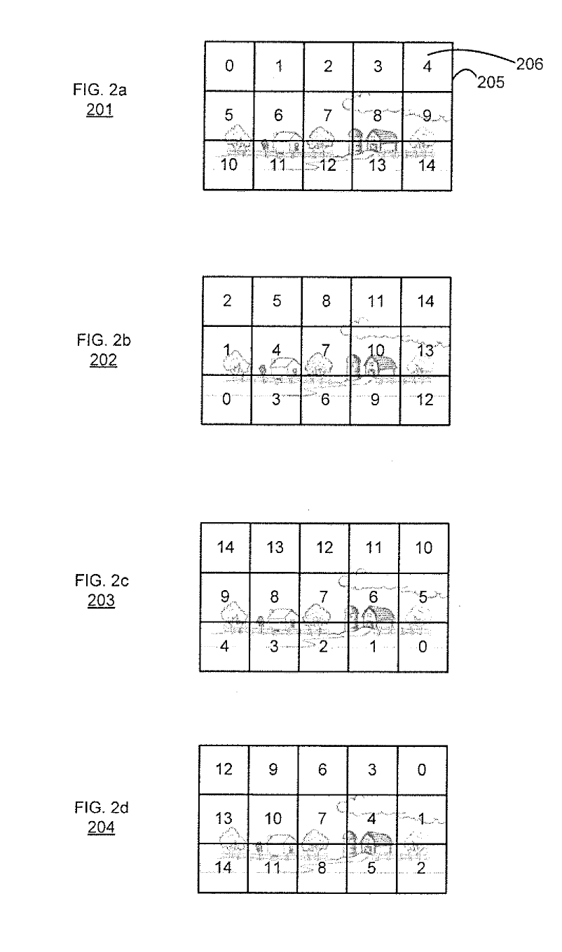

FIGS. 2a through 2d show four different BCOs by indicating the CNs of blocks in a picture with resolution of 5 by 3 LCUs. In FIG. 2a, picture 201 is in BCO mode 0, and in raster scan order. In FIG. 2b, picture 202 is in BCO mode 1, and in a scan order that can be viewed as raster scan order rotated by 90 degrees counter-clockwise. FIG. 2c and FIG. 2d show pictures 203 and 204 with a scan order rotation of 180 and 270 degrees, respectively. In all four pictures 201, 202, 203, 204, each block 205 includes a CN 206 which is indicative to the position of the block in the block order only those blocks are available for decoding according to the disclosed subject matter that have a CN lower than the CN of the block that is to be coded, and that are direct neighbors of the block to be coded.

The bits representing the BCO mode can reside in a high level syntax structure such as a Picture Parameter Set, Slice Parameter Set, or other appropriate location in the bitstream that, advantageously, allows the BCO to change on a picture-by-picture or region-by-region (within a picture) basis.

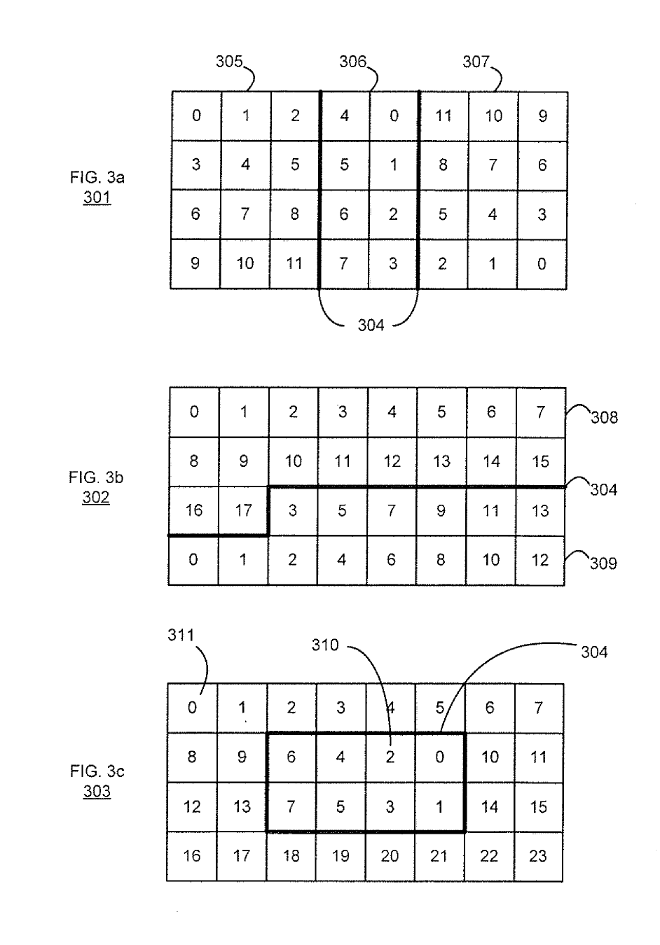

Referring to FIGS. 3a-c, depicted are three pictures 301, 302, 303, each including several regions whose boundaries are indicated through boldface lines 304. As shown, the block coding order of the regions inside pictures 301, 302, 303 can differ, based on the BCO mode for each region.

Referring to FIG. 3a, shown are three regions, each forming a columns of LCUs. Such a picture partitioning can be achieved, for example, using H.264's Flexible Macroblock Ordering or HEVC's Tile mechanisms. The BCO of the leftmost region 305 of picture 301 is in normal raster scan order. In region 306, the BCO is rotated counter-clockwise by 270 degrees, which can correspond to BCO mode 3 as described later. In region 307, the BCO is rotated by 180 degrees which can correspond to BCO mode 2. Referring to FIG. 3b, shown are two regions, separated by a slice boundary as available in both H.264 and HEVC. Region 308 is in normal BCO (scan order, rotation 0 degree) corresponding to BCM mode 0, and in region 309, the BCO is rotated by 90 degrees counter-clockwise, which can correspond to BCO mode 1.

Referring to FIG. 3c, shown is a picture 303 that includes a region of interest 310, separated from the background 311 by the border 304. Such a separation of LCUs is, at the time of writing, not possible in HEVC, but can be implemented in H.264 using Flexible Macroblock Ordering. The background 311 uses raster scan BCO that can correspond to BCO mode 0, whereas the region of interest uses a BCO with a rotation counter-clockwise by 270 degree (BCO mode 3).

A decoder can receive the BCO indication indicative of a BCO mode from a high level syntax structure and use it for purposes as described in more detail later. The high level syntax structure to be used can depend on the video coding standard in use. For example, one appropriate place for the BCO indication when regions are separated by slice boundaries such as in picture 302 would be the slice header. BCO information related to the column-like regions of picture 301 or the region of interest-like regions of picture 303 can be placed, for example in a picture parameter set. Conversely, an encoder can select a value for the BCO indication, encode the blocks according to the selected value and the availability information that can be derived from the BCO indication, and place the BCO indication in a high level syntax element as described.

The selection process can include mechanisms to select the appropriate value for the BCO indication according to different criteria. For example, the selection process can target compression efficiency by performing a rate distortion optimization for some or all of the possible values of the BCO indication. For example, an encoder can encode a region in all possible BCO modes, and select the BCO mode that yields the lowest number of encoded bits at a given quality. Such rate distortion optimization techniques are well known to those skilled in the art of video compression.

### Representation of the BCO Indication

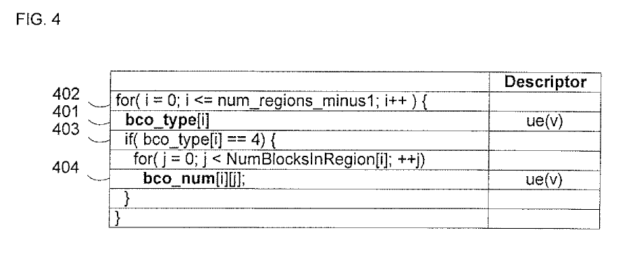

FIG. 4 shows an exemplary syntax based in H.264's syntax notation. The example incorporates a variable length parameter bco_type 401 for each region 402.

The semantics definition, following the conventions of H.264, for bco_type 401 can, for example be specified as follows:
bco_type[i] specifies the block coding order (BCO) type for region i. The valid range of values shall be 0 to 4, inclusively. The below table lists the BCO types.

| bco_type | Value |
|---|---|
| 0 | BCO_TYPE_RASTER_SCAN |
| 1 | BCO_TYPE_ROTATED_90_RASTER_SCAN |
| 2 | BCO_TYPE_ROTATED_180_RASTER_SCAN |
| 3 | BCO_TYPE_ROTATED_270_RASTER_SCAN |
| 4 | BCO_TYPE_EXPLICIT |

Briefly referring to FIGS. 2a through 2d, picture 201 corresponds to bco type equal to 0, picture 202 corresponds to bco_type equal to 1, picture 203 corresponds to bco_type equal to 2, and picture 204 corresponds to bco_type equal to 3. Again referring to FIG. 4, shown is also a mechanism for explicitly signaling CNs for each block, rather than relying on a (possibly rotated) traditional scan order. Specifically, if bco_type has a value of 4 (403), then, for each block (in raster scan order) in the region 404, a bco_num indicative for a CN can be coded. Expressed in the language used to specify semantics in H.264, the semantics of bco_num can, for example, be expressed as
bco_num[i][j] specifies the block CN for the block j of region i. The valid range of values shall be 0 to NumBlocksInRegion[i]−1, inclusively, where NumBlocksInRegion[i] is the number of blocks in region i. This value is only specified for the blocks of the region with bco_type equal to 4.

The syntax structure shown in FIG. 4 and described above can, for example, be placed in a slice header, picture header, picture or sequence parameter set, or any other high level syntax structure. Some criteria for an appropriate selection of the place have already been described above.

In the following, in order to simplify the description, it is assumed that the block coding order mechanism described herein is applied to a complete picture, and the bco_types in use are 0, 1, 2, and 3. Further, the description follows the conventions of the HEVC working draft (WD). Finally, the description is focused on encoding; a decoding process would apply similar mechanisms inversely as would be well understood by persons skilled in the art.

### BCO Transform Functions

Two transform functions, Gx and Gy, are defined for mapping samples in a square block of width nS with bco_type equal to 0 to samples in a corresponding square block with a different bco_type. Similar to other standards that define block-based coding, HEVC only describes processes for blocks coded in raster scan order. Hence, the subsequent sections describe modifications to certain mechanisms in the HEVC working draft for bco_types not equal to 0, so that most of the processes defined in the working draft can be reused. As a result of reusing such defined processes (that assume raster scan order processing), some of the intermediate results need to be transformed using the transform functions below:

Gx(x, y, nS)
If bco_type==0, then return x.
Else if bco type==1, then return y.
Else if bco_type==2, then return nS−1−x.
Else (bco_type==3), return nS−1−y.

Gy(x, y, nS)
If bco_type==0, then return y.
Else if bco_type==1, then return nS−1'x.
Else if bco_type==2, then return nS−1−y.
Else (bco_type==3), return x.

### Parsing/Coding Order

The slice_data( ) syntax specified in HEVC describes the parsing/coding order of each Largest Coding Unit (LCU) in a slice, in a raster scanning order. Each slice specifies first_tb_in_slice, the address of the first LCU in the slice and the address of subsequent LCUs are obtained using the NextTbAddress(CurrTbAddr) function. According to an embodiment, the function NextTbAddress(CurrTbAddr) is modified as below so that the different scanning orders, represented by bcotype, are taken into consideration. For example, when bco_type is equal to 1 for the picture shown in picture 2 (202) of FIG. 2b, if the current LCU address CurrTbAddr is equal to 12 (which corresponds to the LCU with the CN equal to 6), NextTbAddress(CurrTbAddr) returns 7 as the next LCU address (which corresponds to the LCU with CN equal to 7). The definition below modifies the NextTbAddress(CurrTbAddr) function so that the address of each LCU is returned in the order specified by a given block coding order (bco_type):

NextTbAddress(CurrTbAddr)
If bcotype==0, then return CurrTbAddr+1.
Else if bco_type==1, then
   If CurrTbAddr>PicWidthInTbs, then return CurrTbAddr−PieWidthInTbs.
   Else, return CurrTbAddr+(PicHeightInTbs−1)*PicWidthInTbs+1.
Else if bco_type==2, then return CurrTbAddr−1.
Else (bco_type==3), then
   If CurrTbAddr<(PicHeightInTbs−1)*PicWidthInTbs, then return CurrTbAddr+PicWidthInTbs.
   Else, return CurrTbAddr−(PicHeightInTbs−1)*PicWidthInTbs−1.

In the above definition of NextTbAddress(CurrTbAddr), PicWidthInTbs is the width of the picture in number of LCUs and PicHeightInTbs is the height of the picture in number of LCUs.

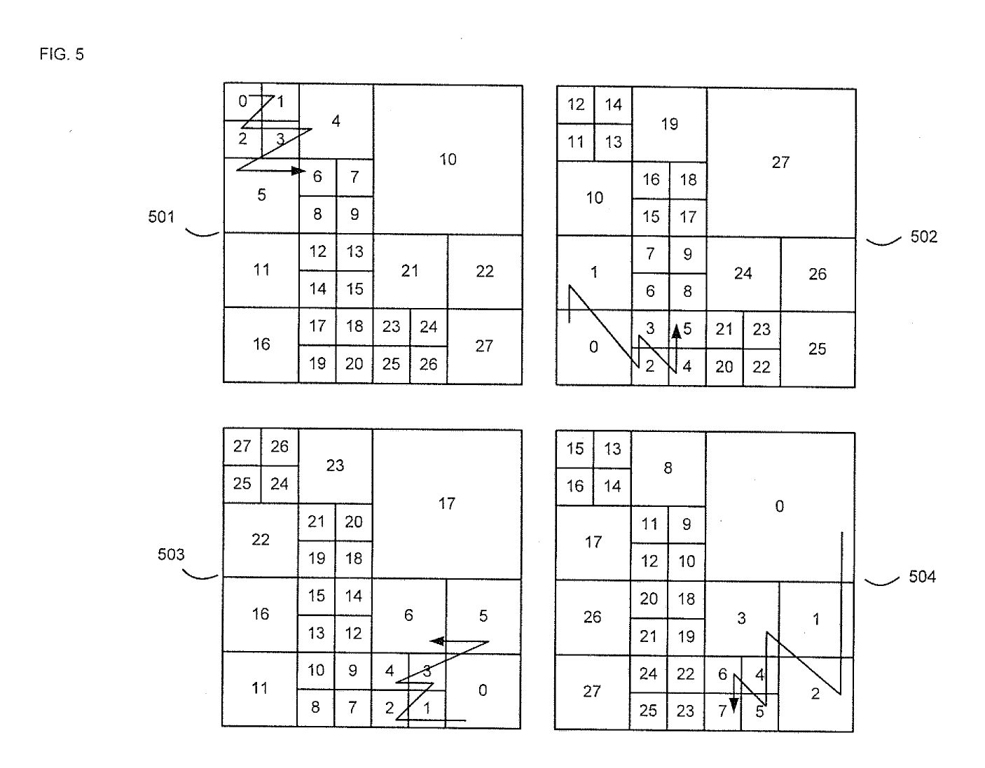

According to HEVC, an LCU can be partitioned into one or more Coding Units (“CUs”) as shown in FIG. 5. Each CU can be parsed/coded according to the CN (which is here to be interpreted as the number of a CU within an LCU, in contrast to the number of an LCU within a picture). LCU (a) 501 shows the CN of each CU when bco_type is equal to 0. LCUs (b) 502, (c) 503, and (d) 504 show the CN of each CU when bco_type is equal to 1, 2, and 3, respectively. An arrow shows an exemplary order of CUs within the LCUs, by connecting CUs with increasing CNs. Note that the actual index of each CU is set with respect to the top-left sample of the LCU, independent of the bco_type. For example, the CU with CN equal to 4 in 501 and the CU with CN equal to 19 in 502 have the same CU index.

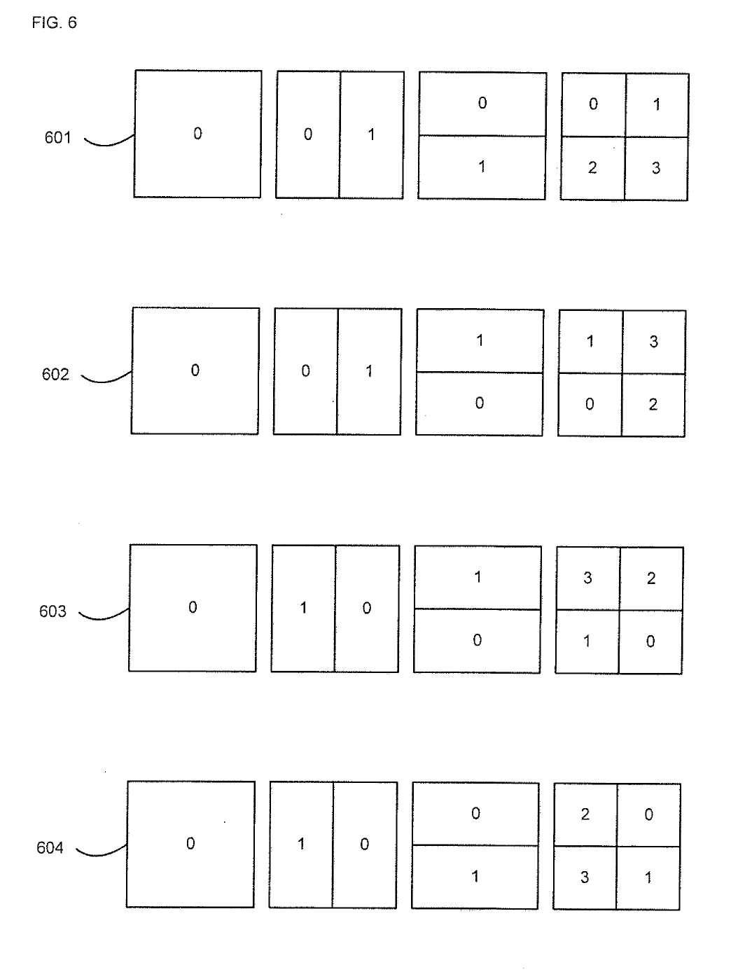

Each CU can be partitioned into one or more Prediction Units (“PUs”) as shown in FIG. 6. Each PU is parsed/coded according to the CN shown in the figure (where the CN is to be interpreted as being within the CU, in contrast to being within the LCU or being within the picture). PUs (a) 601, (b) 602, (c) 603, and (d) 604 show the PU coding order when bco_type is equal to 0, 1, 2, and 3, respectively. Similar to the CU index, the actual index of each PU is set with respect to the top-left sample of the LCU, independent of the bco_type.

Each CU can also (independently) be partitioned into one or more Transform Units (“TUs”) following a similar quadtree structure as the one shown in FIG. 5. The sub-blocks are the TUs of the CU, and the numbers indicate the CN of each TU for different bco_types. Similar to the PU index, the actual index of each TU is set with respect to the top-left sample of the LCU, independent of the bco_type. Once more, CN, in this case, is to be interpreted in the context of encumbering the TUs within a CU (in contrast to numbering LCUs in picture, or PUs in LCU, as described above).

### Intra Coding

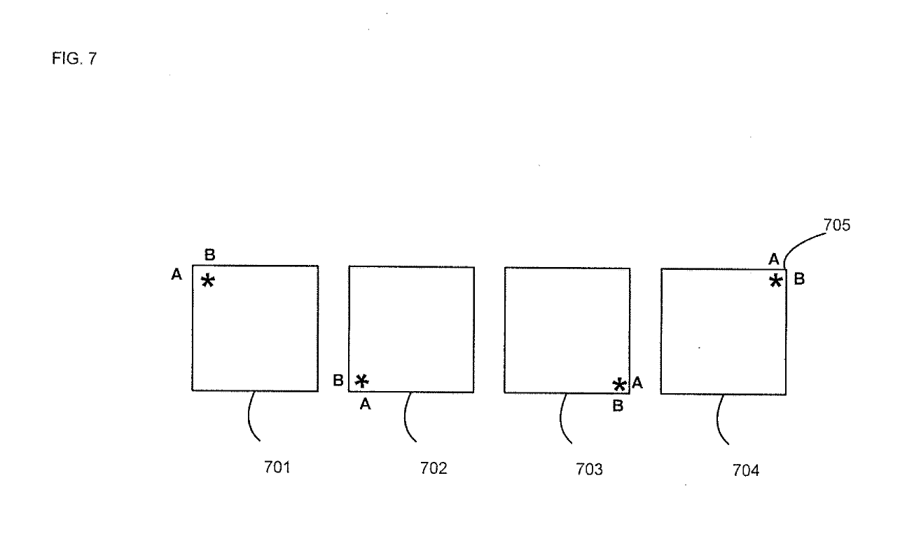

The decoding process for CUs coded in intra prediction mode specified in of HEVC can be used for all BCO types with the following modifications:
In the case of intra coding, each CU can be coded as one PU, or it can be split into four PUs as shown in FIG. 6. Depending on the bco_type, the PUs are coded in the increasing order of their CNs.
For each PU, intra prediction mode is derived using the neighboring PUs' (PUA and PUB) intra prediction modes. PUA is the PU containing the sample A and PUB is the PU containing the sample B, where samples A and B for the current PU are shown in FIG. 7 for each bco_type.

Referring to FIG. 7, the luma location (xCn, yCn) may be the position of the sample, with respect to the top-left sample of the picture, marked by a star symbol (*) 705 when bco_type is equal to n. When bco_type is equal to 0, (*)(xC0, yC0) is the top-left sample of the PU 701, and when bco_type is equal to 1, (*) (xC1, yC1) is the bottom-left sample of the PU 702. For bco_types 2 and 3 equivalent rules apply (i.e., 703 and 704). Note that the chroma samples are located in exactly the same way as the luma samples. For the chroma samples, xCn and/or yCn may be divided by 2 depending on the chroma sample format.

In accordance with the disclosed subject matter, the blocks of various types (including LCUs, CUs, PUs, and TUs) can be coded in a scan order different from the traditional raster scan order, and hence the locations of the previously-coded available samples are in different positions relative the current block (specifically the current PU in the remaining description related to intra prediction). In order to provide a coding efficiency benefit from using previously coded neighboring samples' information, the location of the available neighboring samples A and B are defined differently for each bco_type: when bco_type is equal to 0, A is the sample left of (xC0, yC0) and B is the sample above (xC0, yC0); when bco_type is equal to 1, A is the sample below (xC1, yC1) and B is the sample left of (xC1, yC1); when bco_type is equal to 2, A is the sample right of (xC2, yC2) and B is the sample below (xC2, yC2); and when bco_type is equal to 3, A is the sample above (xC3, yC3) and B is the sample right of (xC3, yC3). This is shown in pseudo-code as follows:
If bco_type==0, then (xCA, yCA) =(xC0−1, yC0) and (xCB, yCB)=(xC0, yC0−1).
Else if bco_type==1, then (xCA, yCA)=(xC1, yC1+1) and (xCB, yCB)=(xC1−1, yC1).
Else if bco type==2, then (xCA, yCA)=(xC2+1, yC2) and (xCB, yCB)=(xC2, yC2+1).
Else (bco_type==3), (xCA, yCA)=(xC3, yC3−1) and (xCB, yCB)=(xC3+1, yC3).

For each PU intra predicted samples (predSamples[x, y]) are obtained as described in HEVC.

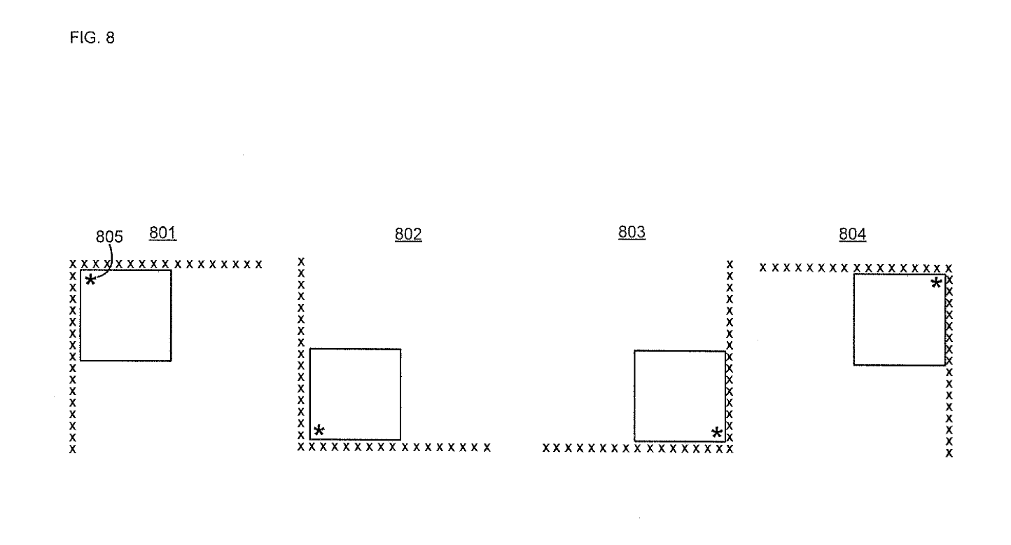

Referring to FIG. 8, the intra predicted samples are derived based on the neighboring samples (p[x, y]), as described in HEVC. Specifically, described in HEVC is a process for obtaining p[x, y] for the case where bco_type is equal to 0. The neighboring samples for this case 801 are shown by the symbol X. FIG. 8 also shows the neighboring samples available for intra prediction for the BCO_types 0, 1, 2, 3, respectively, 801, 802 803, 804. Note that the sample marked by a star symbol (*) 805 corresponds to the luma location (xCn, yCn), with respect to the top-left sample of the picture.

When bco_type is equal to 0, p[x, y] are defined for x=−1 and y=−1 . . . 2*nSp−1 (left neighboring samples), and y=−1 and x=0 . . . 2*nSp−1 (above neighboring samples), where nSp is the width of the current (square) PU and the values for x and y are defined with respect to (xC0, yC0). When bco_type is equal to 1, the neighboring samples should be defined for y=1 and x=−1 . . . 2*nSp−1 (bottom neighboring samples), and x=−1 and y=0 . . . −2*nSp+1 (left neighboring samples) with respect to (xC1, yC1). However, to reuse most of the text for describing the predSamples[x, y] derivation process described in HEVC, the neighboring samples for a given bco_type can be mapped to the neighboring sample definition p[x, y] when bco_type is equal to 0: when bco_type is equal to 1, bottom neighboring samples are assigned as the left neighboring samples of p[x, y] and left neighboring samples are assigned as the above neighboring samples of p[x, y]; when bco_type is equal to 2, right neighboring samples are assigned as the left neighboring samples of p[x, y] and bottom neighboring samples are assigned as the above neighboring samples of p[x, y]; when bco_type is equal to 3, above neighboring samples are assigned as the left neighboring samples of p[x, y] and right neighboring samples are assigned as the above neighboring samples of p[x, y]. This mapping is shown in pseudo-code as follows:

```
If bco_type == 0, then
      For y = −1 .. 2*nSp−1, p[−1, y] = s[xC0−1, yC0+y]
      For x = 0 .. 2*nSp−1, p[x, −1] = s[xC0+x, yC0−1]
Else if bco_type == 1, then
      For y = −1 .. 2*nSp−1, p[−1, y] = s[xC1+y, yC1+1]
      For x = 0 .. 2*nSp−1, p[x, −1] = s[xC1−1, yC1−x]
Else if bco_type == 2, then
      For y = −1 .. 2*nSp−1, p[−1, y] = s[xC2+1, yC2−y]
      For x = 0 .. 2*nSp−1, p[x, −1] = s[xC2−x, yC2+1]
Else (bco_type == 3),
      For y = −1 .. 2*nSp−1, p[−1, y] = s[xC3−y, yC3−1]
      For x = 0 .. 2*nSp−1, p[x, −1] = s[xC3+1, yC3+x]
```

In the above description, s is the constructed sample prior to the deblocking filter process.

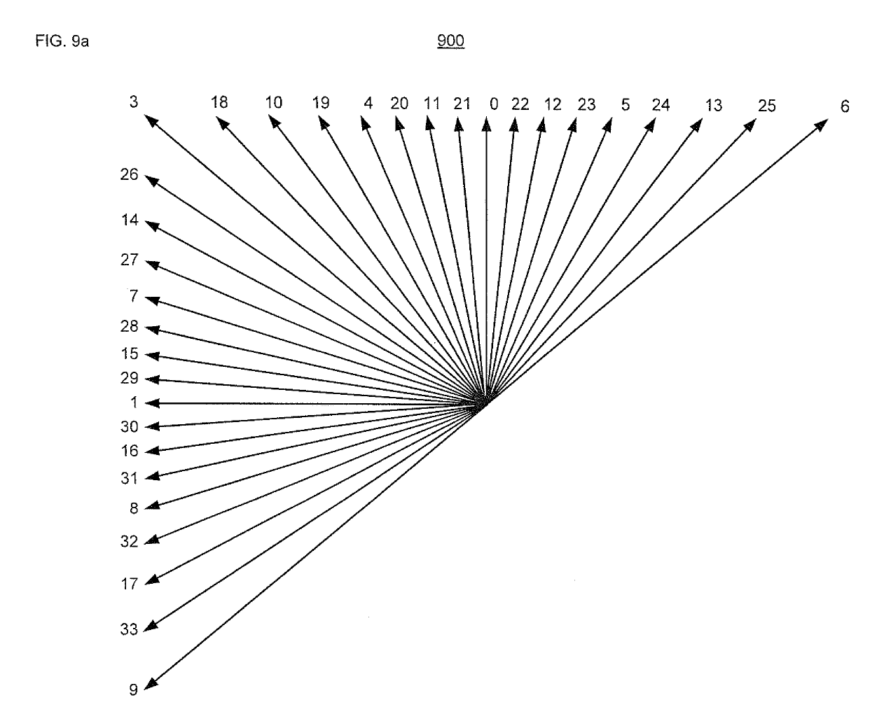

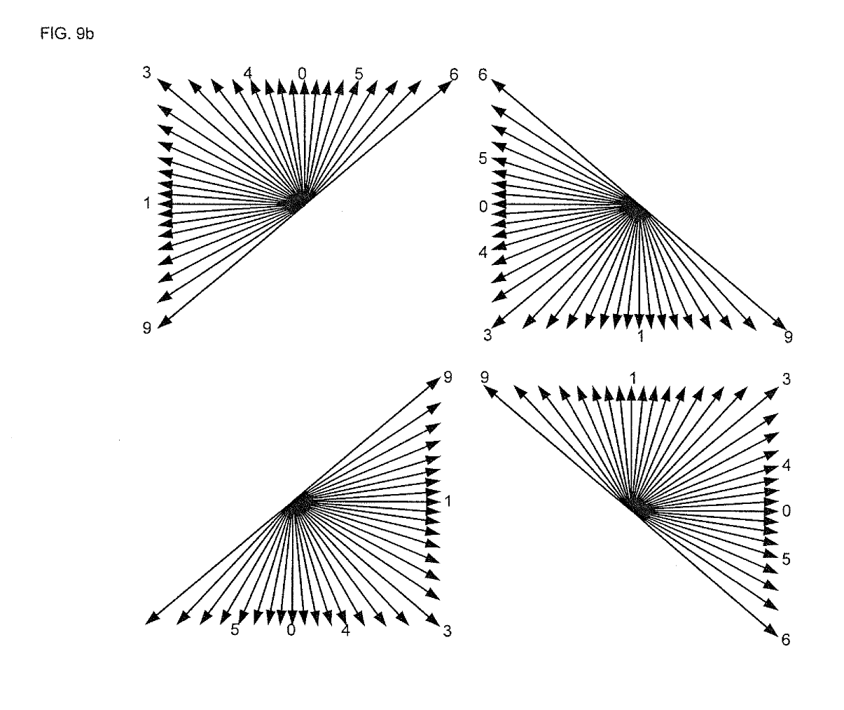

When bco_type is equal to 0, the supported intra luma prediction directions are shown in FIG. 9(a). (The figure is reproduced from HEVC.) By making the above transformation as a function of bco_type, the same prediction directions can be used.

As an alternative, without such transformation, the directions shown in FIG. 9b would have to be used when bco_type is equal to 0 (901), 1 (902), 2 (903), and 3 (904), respectively. Please note that not all directions in FIG. 9b are enumerated; the not enumerated directions can easily be determined by referring to FIG. 9a 900, and rotating that figure appropriately.

After p[x, y] are constructed as specified above, the remainder of HEVC's intra prediction mechanisms can readily be applied with, for example, one of the following two modifications:
Option 1: After obtaining the predicted samples predSamples[x, y] as stated in the HEVC WD, rotate the samples according to the bco_type.
Option 2: In order to avoid the rotation in Option 1, replace the assignment equations to predSamples[x, y] with predSamples[Gx(x, y, nSp), Gy(x, y, nSp)], where the functions Gx and Gy are defined above.

### Inter Coding

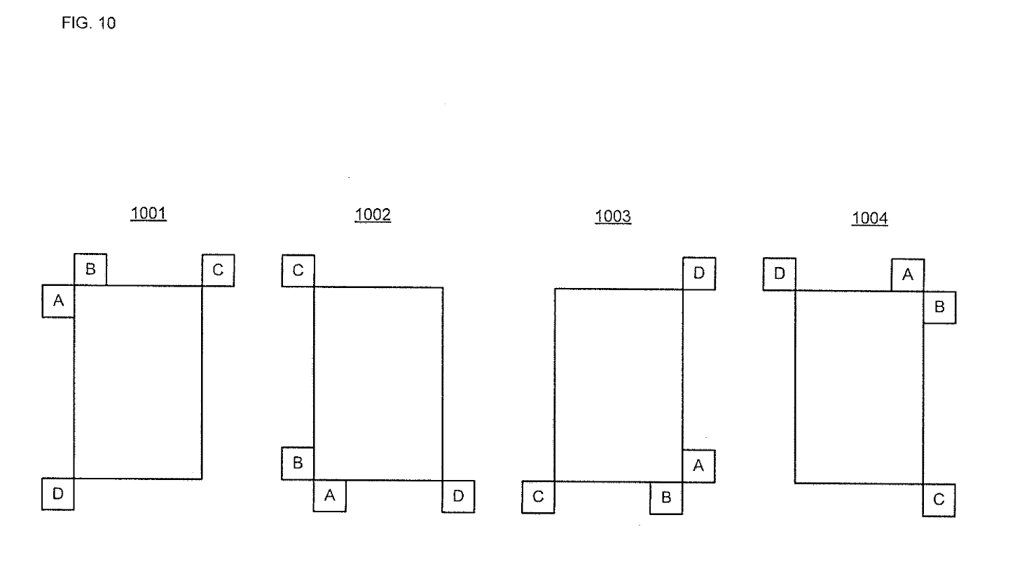

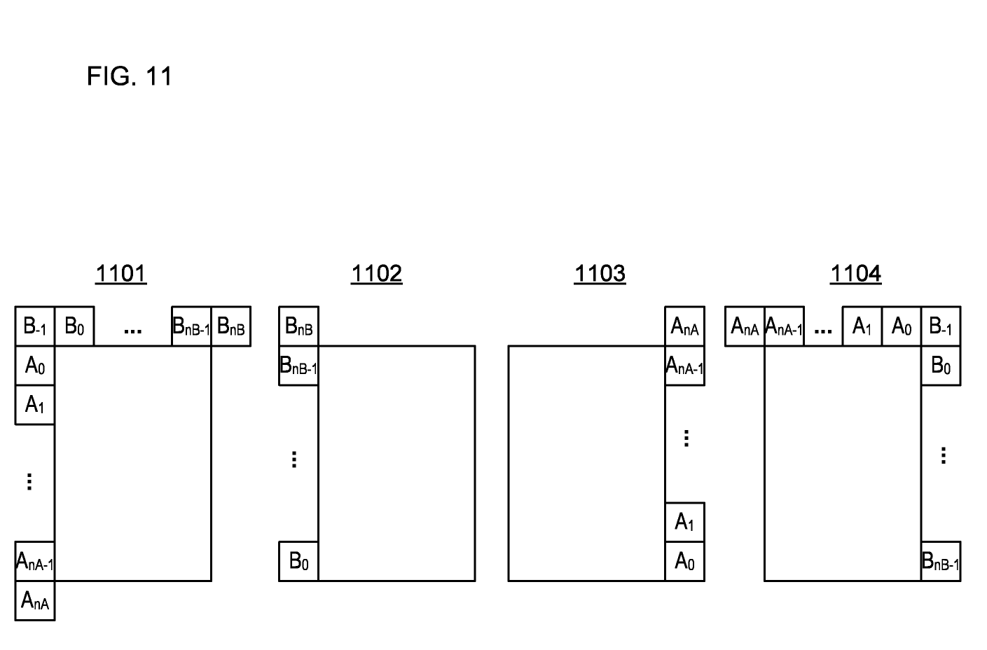

The decoding process for CUs coded in inter prediction mode specified in of HEVC can be used for all BCO types with the following modifications:
A CU can be partitioned into one or more PUs as shown in FIG. 6. The order in which each PU is coded is depicted by the PU CNs shown in the figure, which has already been described.
Referring to FIG. 10, if a PU is coded in merge mode, then spatial merging candidates can be derived from the available neighboring PUs that correspond to the neighboring samples A, B, C, and D as shown in FIG. 10 for bco_type 0 1001, 1 1002, 2 1003, and 3 1004. Note that when a CU is partitioned into more than one PU, the reason for such partitioning can be that each partition has different motion information. Hence, the motion information of the previously coded PUs of the same CU is not used as a merge candidate. HEVC describes this restriction for the case where bco type is equal to 0. This section can be modified so that the different PU coding order is taken account when bco_type is different from 0.
For other inter coded cases, the motion vector predictor candidates can bederived from the available neighboring PUs: PUA and PUB. The process described in HEVC for deriving PUA and PUB can be modified, for example, as follows: The spatial neighbors that can be used as motion information candidates are dependent on the bco_type as shown in FIG. 11. PUA is the PU (if available and inter coded) containing one of the samples Ak where k=0 . . . nA, and PUB is the PU (if available and inter coded) containing one of the samples Bk, where k=−1 . . . nB. Note the different sample locations for Ak and Bk dependent on the bco_type: locations are indicated for bco_type 0 1101, 1 1102, 2 1103, and 3 1104.
For the derivation of temporal lama motion information of a collocated PU (the PU of a reference picture), the process specified in the HEVC can be directly used as the collocated PU is just the PU containing a collocated sample of the current PU.

### Inverse Scanning Process for Transform Coefficients

The inverse scanning process for transform coefficients specified in HEVC maps sequentially arranged transform coefficients to a two-dimensional array c. Depending on the prediction mode (intra or inter) and, in the case of intra, intra prediction mode, a different inverse scanning process is specified. In the HEVC WD, the scanning process is specified for the case where bco_type is equal to 0 as cxy=listTrCoeff[f(x, y)] where listTrCoeff contains a list of the sequentially arranged transform coefficients and f(x, y) is a mapping function specified in the HEVC WD. For example, in the case where the PU is coded as intra with horizontal intra prediction, f(x, y) is specified as f(x, y)=x+y*nSt, where nSt is the width of the square TU.

To support different bco_types, we can use the BCO transform functions defined in 5.B.1 as follows: cx′y′=listTrCoeff[f(x, y)], where x′=Gx(x, y, nSt) and y′=Gy(x, y, nSt).

It will be understood that in accordance with the disclosed subject matter, the techniques described herein can be implemented using any suitable combination of hardware and software. The software (i.e., instructions) for implementing and operating the aforementioned techniques can be provided on computer-readable media, which can include, without limitation, firmware, memory, storage devices, microcontrollers, microprocessors, integrated circuits, ASICs, on-line downloadable media, and other available media.

### Computer System

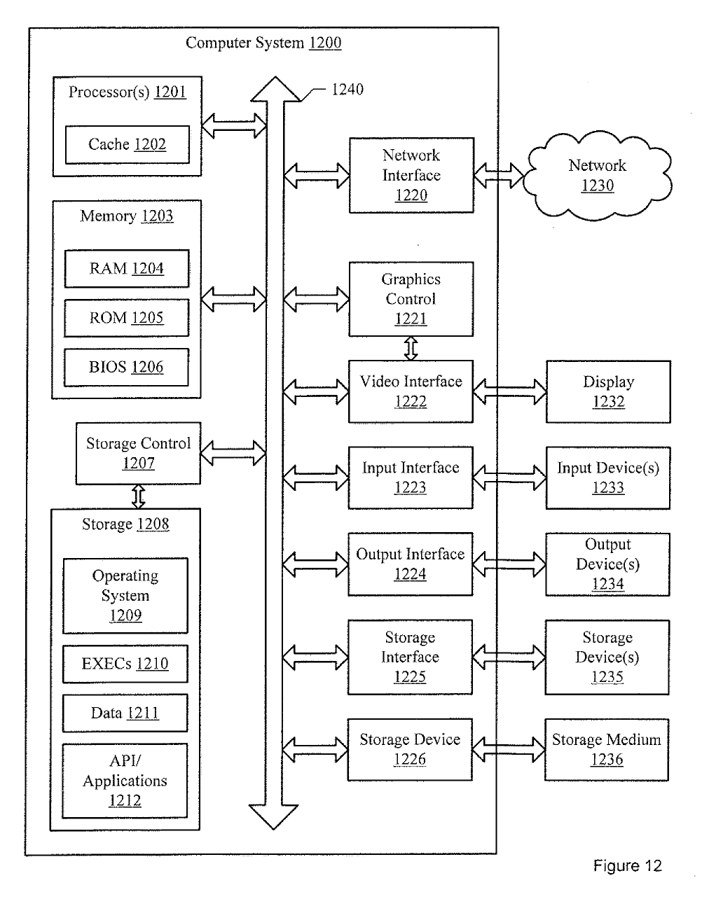

The methods described above can be implemented as computer software using computer-readable instructions and physically stored in computer-readable medium. The computer software can be encoded using any suitable computer languages. The software instructions can be executed on various types of computers. For example, FIG. 12 illustrates a computer system 1200 suitable for implementing embodiments of the present disclosure.

Referring now to FIG. 12, the components shown therein for computer system 1200 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Computer system 1200 can have many physical forms including an integrated circuit, a printed circuit board, a small handheld device (such as a mobile telephone or PDA), a personal computer or a super computer.

Computer system 1200 includes a display 1232, one or more input devices 1233 (e.g., keypad, keyboard, mouse, stylus, etc.), one or more output devices 1234 (e.g., speaker), one or more storage devices 1235, various types of storage medium 1236.

The system bus 1240 link a wide variety of subsystems. As understood by those skilled in the art, a “bus” refers to a plurality of digital signal lines serving a common function. The system bus 1240 can be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 1201 (also referred to as central processing units, or CPUs) optionally contain a cache memory unit 1202 for temporary local storage of instructions, data, or computer addresses. Processor(s) 1201 are coupled to storage devices including memory 1203. Memory 1203 includes random access memory (RAM) 1204 and read-only memory (ROM) 1205. As is well known in the art, ROM 1205 acts to transfer data and instructions uni-directionally to the processor(s) 1201, and RAM 1204 is used typically to transfer data and instructions in a bi-directional manner. Both of these types of memories can include any suitable of the computer-readable media described below.

A fixed storage 1208 is also coupled bi-directionally to the processor(s) 1201, optionally via a storage control unit 1207. It provides additional data storage capacity and can also include any of the computer-readable media described below. Storage 1208 can be used to store operating system 1209, EXECs 1210, application programs 1212, data 1211 and the like and is typically a secondary storage medium (such as a hard disk) that is slower than primary storage. It should be appreciated that the information retained within storage 1208, can, in appropriate cases, be incorporated in standard fashion as virtual memory in memory 1203.

Processor(s) 1201 is also coupled to a variety of interfaces such as graphics control 1221, video interface 1222, input interface 1223, output interface, storage interface, and these interfaces in turn are coupled to the appropriate devices. In general, an input/output device can be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 1201 can be coupled to another computer or telecommunications network 1230 using network interface 1220. With such a network interface 1220, it is contemplated that the CPU 1201 might receive information from the network 1230, or might output information to the network in the course of performing the above-described method. Furthermore, method embodiments of the present disclosure can execute solely upon CPU 1201 or can execute over a network 1230 such as the Internet in conjunction with a remote CPU 1201 that shares a portion of the processing.

According to various embodiments, when in a network environment, i.e., when computer system 1200 is connected to network 1230, computer system 1200 can communicate with other devices that are also connected to network 1230. Communications can be sent to and from computer system 1200 via network interface 1220. For example, incoming communications, such as a request or a response from another device, in the form of one or more packets, can be received from network 1230 at network interface 1220 and stored in selected sections in memory 1203 for processing. Outgoing communications, such as a request or a response to another device, again in the form of one or more packets, can also be stored in selected sections in memory 1203 and sent out to network 1230 at network interface 1220. Processor(s) 1201 can access these communication packets stored in memory 1203 for processing.

In addition, embodiments of the present disclosure further relate to computer storage products with a computer-readable medium that have computer code thereon for performing various computer-implemented operations. The media and computer code can be those specially designed and constructed for the purposes of the present disclosure, or they can be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter. Those skilled in the art should also understand that term “computer readable media” as used in connection with the presently disclosed subject matter does not encompass transmission media, carrier waves, or other transitory signals.

As an example and not by way of limitation, the computer system having architecture 1200 can provide functionality as a result of processor(s) 1201 executing software embodied in one or more tangible, computer-readable media, such as memory 1203. The software implementing various embodiments of the present disclosure can be stored in memory 1203 and executed by processor(s) 1201. A computer-readable medium can include one or more memory devices, according to particular needs. Memory 1203 can read the software from one or more other computer-readable media, such as mass storage device(s) 1235 or from one or more other sources via communication interface. The software can cause processor(s) 1201 to execute particular processes or particular parts of particular processes described herein, including defining data structures stored in memory 1203 and modifying such data structures according to the processes defined by the software. In addition or as an alternative, the computer system can provide functionality as a result of logic hardwired or otherwise embodied in a circuit, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents which fall within the scope of the disclosed subject matter. It should also be noted that there are many alternative ways of implementing the methods and apparatuses of the disclosed subject matter.

We claim:

1. A method for decoding video which is represented by two or more blocks, comprising:
receiving at least one syntax element indicative of a block coding order (BCO); and
decoding at least one of the two or more blocks in accordance with the BCO.

2. The method of claim 1, wherein the syntax element indicative of the BCO is part of a parameter set.

3. The method of claim 2, wherein the parameter set comprises a picture parameter set.

4. The method of claim 1, wherein the syntax element comprises at least a portion of a slice header.

5. The method of claim 1, further comprising:
during the decoding, determining an availability of at least one sample for prediction by using the BCO.

6. The method of claim 1, further comprising: using at least one coding tool of High Efficiency Video Coding (HEVC).

7. The method of claim 1, wherein the syntax element indicative of a BCO is associated with a region of a picture.

8. The method of claim 7, wherein the region is selected from the group consisting of a slice, a column, and a region of interest.

9. The method of claim 7, wherein the region is selected from the group consisting of two or more of: a slice, a column, and a region of interest.

10. A method for encoding video which is represented by two or more blocks, comprising
determining for at least one region of a picture a block coding order (BCO) different than scan order;
encoding at least one syntax element indicative of the determined BCO; and
encoding at least one of the two or more blocks;
during the encoding at least one of the two or more blocks, determining availability of at least one sample for prediction by using the BCO.

11. The method of claim 9, wherein the determining uses rate-distortion optimization.

12. A system for decoding video which is represented by two or more blocks, comprising:
a decoder configured to:
receive at least one syntax element indicative of a block coding order (BCO); and
decode at least one of the two or more blocks in accordance with the BCO.

13. A system for encoding video which is represented by two or more blocks comprising:
an encoder configured to:
determine for at least one region of a picture a block coding order (BCO) different than scan order;
encode at least one syntax element indicative of the determined BCO; and
encode at least one of the two or more blocks;
during the encoding at least one of the two or more blocks, determine availability of at least one sample for prediction by using the BCO.

14. A non-transitory computer readable medium comprising a set of instructions to direct a processor to perform the methods of one of claims 1 to 11.
